(19) United States
(12) Patent Application Publication
(10) Pub. No.: US 2010/0209079 A1
(43) Pub. Date: Aug. 19, 2010

(54) RECORD REPRODUCING APPARATUS

(76) Inventors: Masato Kihara, Shiga (JP); Ken Nagai, Osaka (JP); Tsuyoshi Yoshii, Osaka (JP); Miki Shimizu, Osaka (JP); Chikashi Hayashi, Osaka (JP); Yasunori Kawakami, Hyogo (JP)

Correspondence Address: MCDERMOTT WILL & EMERY LLP, 600 13TH STREET, NW, WASHINGTON, DC, 20005-3096, US

(21) Appl. No.: 12/667,633

(22) PCT Filed: Jun. 27, 2008
(86) PCT No.: PCT/JP2008/001685

§ 371 Date: Jan. 4, 2010

(30) Foreign Application Priority Data
Sep. 6, 2007 (JP) 2007-231644

(51) Int. Cl. H04N 5/00

(52) U.S. Cl. 386/126; 386/E05.064

(57) ABSTRACT

In a DVD+VR recording method, when a VCPS (Video Content Protection System) title (204) recorded under protection of its copyright is recorded in a VCPS-incapable apparatus, a dummy title (203) having a protection attribute is provided immediately before the VCPS title, and information about the dummy title is included in title management information for VCPS-incapable apparatuses and information about the VCPS title is not included in the title management information for VCPS-incapable apparatuses. As a result, even when a user tries to perform overwriting from a deleted title immediately before a VCPS title in a VCPS-incapable apparatus, the recording is stopped as the dummy title has the protection attribute, whereby the VCPS title is prevented from being deleted.

### TECHNICAL FIELD

The present invention relates to recording and playback of optical disks. More particularly, the present invention relates to techniques of preventing overwriting which is not intended by a user.

### BACKGROUND ART

As one of methods of recording optical disks, there is the DVD (Digital Versatile Disk)+VR (Video Recording) recording method (see PATENT DOCUMENT 1).

In the DVD+VR recording method, recording is performed with respect to a continuous recording area as in VTRs (Video Tape Recorders), and overwriting can be performed until reaching an area in which a title having a recording protection attribute is provided.

Also, in the DVD+VR recording method, when a title is deleted, the title is handled as a deleted title. The deleted title indicates a title which is deleted by a user and whose area is not free space, i.e., a title in a managed state that AV data is present in the area, but cannot be played. Also, in the DVD+VR recording method, the deleted title can be overwritten.

Incidentally, the first version of the DVD+VR recording method did not support a copyright protection technology, and therefore, cannot deal with a copyright-protected content. Therefore, the VCPS (Video Content Protection System), which is a copyright protection technique, has been introduced to the DVD+VR standard.

Moreover, in the VCPS version 1.34 and thereafter, management information has been added, taking into consideration VCPS-capable apparatuses and VCPS-incapable apparatuses. In media in which a copyright-protected title (referred to hereinafter as a VCPS title) is recorded, the management information includes title management information for VCPS-capable apparatuses and title management information for VCPS-incapable apparatuses.

The title management information for VCPS-capable apparatuses is used to manage title information of non-copyright-protected titles (referred to hereinafter as conventional titles) which are recorded by the conventional DVD+VR recording method, and title information of VCPS titles. The title management information for VCPS-incapable apparatuses is used to manage only title information of conventional titles. As a result, VCPS titles can be played only by VCPS-capable apparatuses, and cannot be played by VCPS-incapable apparatuses. Note that conventional titles can be played by both types of apparatuses.

### CITATION LIST

### Patent Document

PATENT DOCUMENT 1: Japanese Laid-Open Patent Publication No. 2006-318595

### SUMMARY OF THE INVENTION

### Technical Problem

In the DVD+VR recording method, if a deleted title and a VCPS title are contiguously recorded on a medium in this stated order, then when the deleted title is overwritten, the VCPS title may also be overwritten.

In VCPS-capable apparatuses, the presence of a VCPS title is managed using the title management information, and therefore, a user performs overwriting while recognizing the VCPS title. On the other hand, in VCPS-incapable apparatuses, VCPS titles are not managed using the title management information, and therefore, a user may perform overwriting without the knowledge of the presence of a VCPS title, which is a problem.

The present invention has been made to solve the aforementioned problem. It is an object of the present invention to prevent a user from overwriting a VCPS title without the knowledge of the presence of the VCPS title in VCPS-incapable apparatuses.

### Solution to the Problem

To solve the aforementioned problem, the present invention provides a recording and playback apparatus for recording AV data and management information data of a program, as a title, into an information recording medium in accordance with an information recording format. The apparatus includes an AV data recording unit configured to record AV data into successive recording areas with progression of time, and a dummy title recording unit configured to record a dummy title into an area immediately before an area where AV data is recorded. As a result, it is possible to prevent a title provided in a contiguous area from being overwritten.

The apparatus may include a dummy title protect setting unit configured to set a protection attribute for the dummy title. As a result, it is possible to prevent a title provided in a contiguous area from being overwritten.

The apparatus may include a unit configured to record the dummy title as AV data indicating that the AV data is recorded as a copyright-protected title, but cannot be played. As a result, it is possible to notify the presence of a title which cannot be recognized by a user.

The apparatus may include a unit configured to record the dummy title as AV data indicating that a copyright-protected title is likely to be overwritten if the dummy title is deleted or overwritten. As a result, it is possible to warn a user about the possibility that a title which is not recognized by the user will be deleted.

When a copyright content is recorded by the AV data recording unit, information about a VCPS title and the dummy title may be reflected on first title management information which is management information for copyright-protected title playback-capable apparatuses, and only information about the dummy title may be reflected on second title management information which is management information for copyright-protected title playback-incapable apparatuses. As a result, it is possible to notify the presence of a title which cannot be recognized by a user.

When AV data which is a copyright content is recorded as a copyright-protected title by the AV data recording unit, only information about the copyright-protected title may be reflected on first title management information, and only information about the dummy title may be reflected on second title management information. As a result, it is possible to notify the presence of a title which cannot be recognized by a user.

The apparatus may include a menu screen creating unit configured to create a playback menu screen which is a link destination of a copyright-protected title on a playback menu screen, using the dummy title rather than newly prepared AV data. As a result, it is possible to remove a step of newly preparing a link destination of a copyright-protected title.

The apparatus may include a title deleting unit configured to delete a copyright-protected title recorded along with the dummy title when the dummy title is deleted in another apparatus. As a result, it is possible to maintain consistency between the title management information for VCPS-incapable apparatuses and the title management information for VCPS-capable apparatuses.

The apparatus may include a title recovering unit configured to recover the dummy title when the dummy title is deleted in another apparatus. As a result, it is possible to maintain consistency between the title management information for VCPS-incapable apparatuses and the title management information for VCPS-capable apparatuses.

The title deleting unit may delete a copyright-protected title only when the copyright-protected title is likely to have been overwritten. As a result, it is possible to maintain consistency between the title management information for VCPS-incapable apparatuses and the title management information for VCPS-capable apparatuses.

The information recording format may be the DVD+VR format.

Also, the present invention provides an integrated circuit including an AV data recording unit configured to record AV data into successive recording areas with progression of time, and a dummy title recording unit configured to record a dummy title into an area immediately before an area where AV data is recorded.

### ADVANTAGES OF THE INVENTION

According to the present invention, a dummy title having a recording protection attribute is provided immediately before a VCPS title, whereby a VCPS title which is not recognized by a user can be prevented from being overwritten in a VCPS-incapable apparatus.

Also, AV data of the dummy title is used to notify a user that a dummy title is provided in place of a VCPS title or that a VCPS title is likely to be deleted by deleting the dummy title or canceling a protection attribute, by displaying character information on a display or providing audio information through a loudspeaker, for example. As a result, in a VCPS-incapable apparatus, a user is warned about an operation or title editing, whereby the user is prevented from deleting a title which is not intended by the user.

### BRIEF DESCRIPTION OF THE DRAWINGS

FIG. 1 is a block diagram showing a form of a process of a recording and playback apparatus according to Embodiment 1 of the present invention.

FIG. 2 is a diagram for describing management information in Embodiment 1 of the present invention.

FIG. 3 is a flowchart showing a procedure of the recording and playback apparatus of Embodiment 1 of the present invention.

FIG. 4 is another flowchart showing a procedure of the recording and playback apparatus of Embodiment 1 of the present invention.

FIG. 5 is a diagram showing a screen display for describing the contents of a medium in Embodiment 2 of the present invention.

FIG. 6 is a flowchart showing a procedure of managing a disk in Embodiment 3 of the present invention.

FIG. 7 is a flowchart showing a procedure of managing a disk in Embodiment 4 of the present invention.

FIG. 8 is a flowchart showing a procedure of managing a disk in Embodiment 5 of the present invention.

FIG. 9 is a diagram showing a method of creating a disk playback menu in Embodiment 6 of the present invention.

### DESCRIPTION OF EMBODIMENTS

A VCPS-capable DVD+VR recording method which is used when a copyright-protected content is recorded onto an optical disk will be described hereinafter as an embodiment of the present invention with reference to the representative drawings. Note that the present invention is not limited to VCPS of the DVD+VR recording method and may be applied to a recording method having a plurality of pieces of title management information. Also, the recording medium is not limited to optical disks.

### Embodiment 1

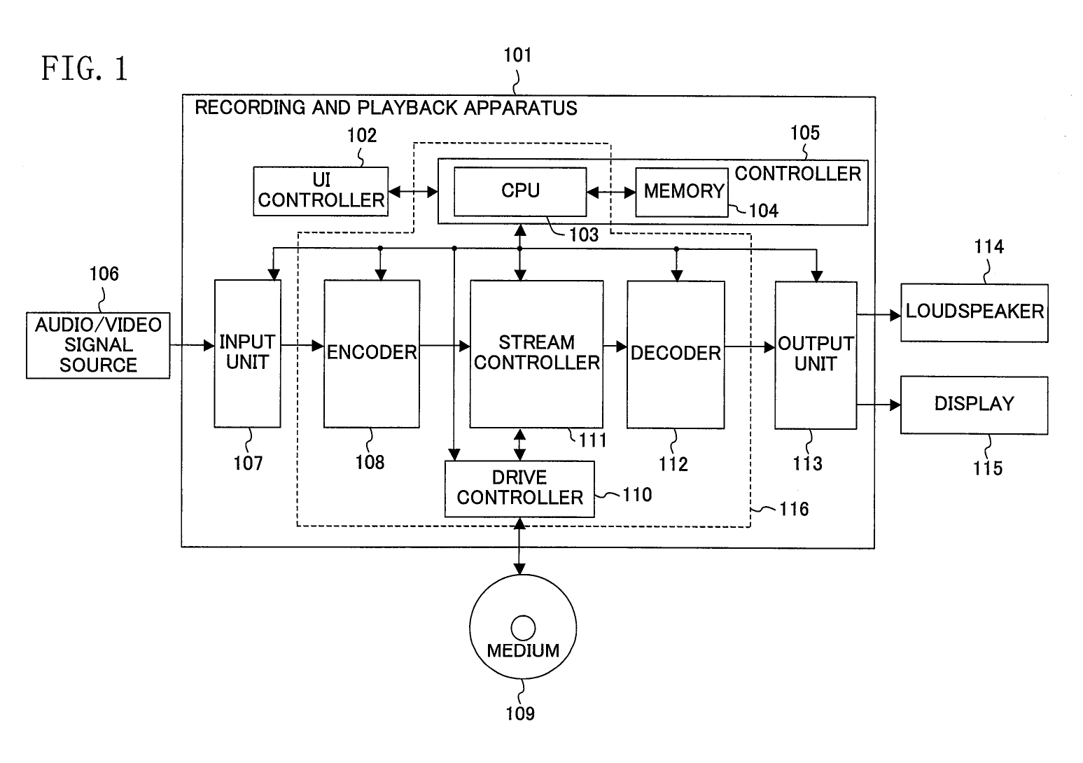

FIG. 1 is a block diagram showing a form of a process of a recording and playback apparatus according to Embodiment 1 of the present invention. As shown in FIG. 1, a recording and playback apparatus 101 includes a UI (User Interface) controller 102, a controller 105 including a CPU (Central Processing Unit) 103 and a memory 104, an input unit 107, an encoder 108, a drive controller 110, a stream controller 111, a decoder 112, and an output unit 113.

An audio/video signal source 106 is assumed to be a tuner or an AV playback apparatus, a medium 109 is assumed to be a rewritable and VCPS-capable DVD+RW, and a loudspeaker 114 and a display 115 are assumed to be a video display apparatus, such as a plasma television, a liquid crystal television or the like.

As shown in FIG. 1, the controller 105 of the recording and playback apparatus 101 includes the CPU 103 and the memory 104. The memory 104 includes a ROM (Read Only Memory) which stores a program and data required for control of the recording and playback apparatus 101, and a RAM (Random Access Memory) which is used as a work area by the CPU 103.

The drive controller 110, which carries out a read/write operation with respect to the medium 109, includes a pickup controller, a mechanical controller and the like. The controller 105 controls the encoder 108, the stream controller 111 and the drive controller 110 to perform recording/playback control with respect to the medium 109 in accordance with the DVD+VR recording method.

The UI controller 102 enables a user to perform an operation. The UI controller 102 may be a keyboard or a remote control. The controller 105 controls operation of the recording and playback apparatus 101 in accordance with the aforementioned user's operation.

The audio/video signal source 106 supplies a broadcast signal received through an antenna, or an audio/video output signal of an AV playback apparatus.

The input unit 107 converts an input signal from the audio/video signal source 106 into digital data using an A/D converter, and outputs the resultant digital data to the encoder 108.

The encoder 108 performs an encoding process with respect to the aforementioned digital data in accordance with a command from the controller 105. Here, the encoding process refers to a process of encoding digital data to generate AV data in the form of a program stream compliant with the MPEG standard.

When recording is performed, the stream controller 111 writes AV data of the encoder 108 via the drive controller 110 to the medium 109, and writes management information of the encoded AV data to the medium 109 in accordance with a command from the controller 105, whereby recording is completed.

Also, when playback is performed, the stream controller 111 reads out management information and AV data from the medium 109, the decoder 112 decodes the AV data into digital data in accordance with the management information, and the output unit 113 D/A converts the digital data into analog data and outputs the analog data to the loudspeaker 114 and the display 115.

Also, when editing is performed, the UI controller 102 receives a user's editing operation, the controller 105 performs editing control with respect to the stream controller 111 and the drive controller 110 in accordance with the DVD+VR recording method so that edited data is reflected on management information of AV data in the medium 109.

In the example of FIG. 1, reference numeral 116 indicates a single system LSI including the CPU 103, the encoder 108, the drive controller 110, the stream controller 111 and the decoder 112.

In the aforementioned system configuration, a case where a VCPS title is recorded onto the medium 109 by the DVD+VR recording method in accordance with the controller 105, will be particularly described.

In the DVD+VR recording method, a finalizing process is performed when the medium 109 is removed from an optical drive. In the finalizing process, the controller 105 controls the drive controller 110, the stream controller 111 and the decoder 112 in accordance with recorded and edited information stored in the memory 104, to record a menu screen showing a list of titles on a disk or information about the titles onto the medium 109.

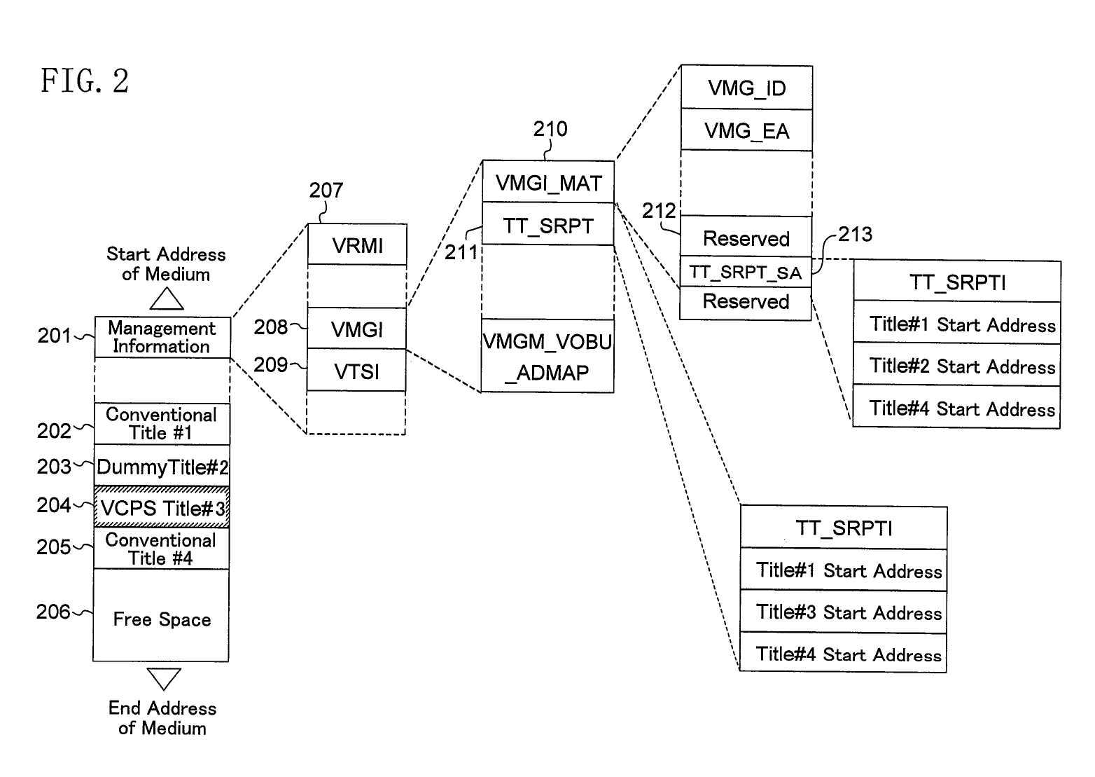

As shown in FIG. 2, in accordance with the DVD+VR recording method, management information 201 is recorded onto the medium 109, and titles (202, 203, 204 and 205) of AV data are recorded into successive areas on the medium 109. Reference numeral 206 indicates a free space.

In the DVD+VR recording method, the management information 201 includes a VRMI (Video Recording Manager Information) 207, VMGI (Video Manager Information) 208, VTSI (Video Title Set Information) 209 and the like.

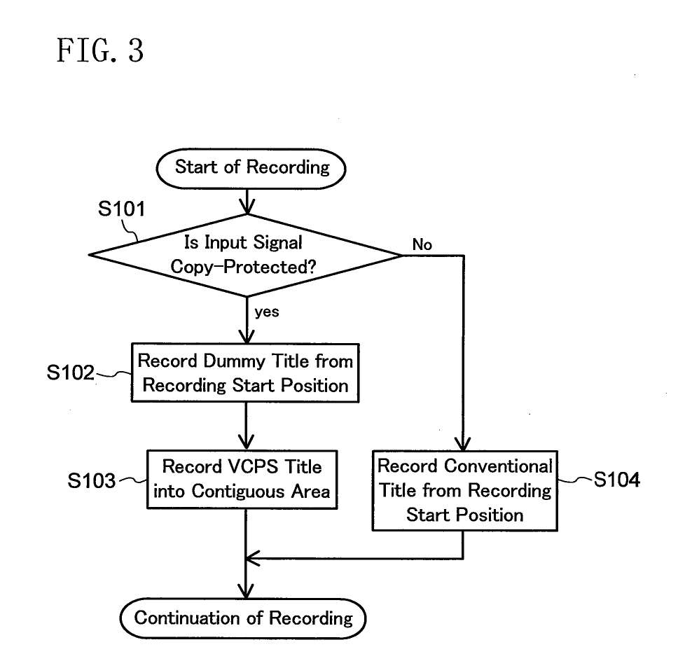

As shown in FIG. 3, in step S101, the input unit 107 detects that an output signal of the audio/video signal source 106 is a copyright-protected content. In step S102, in response to this, the controller 105 records a dummy title into an area immediately before an area in which a VCPS title is to be recorded. AV data for creating the dummy title is stored as fixed data in the memory 104. The AV data may be stored in an external storage medium, such as an HDD or the like. Next, in step S103, a VCPS title is recorded into the contiguous area. Note that, when a copyright signal is not detected in step S101, only a conventional title is recorded in step S104.

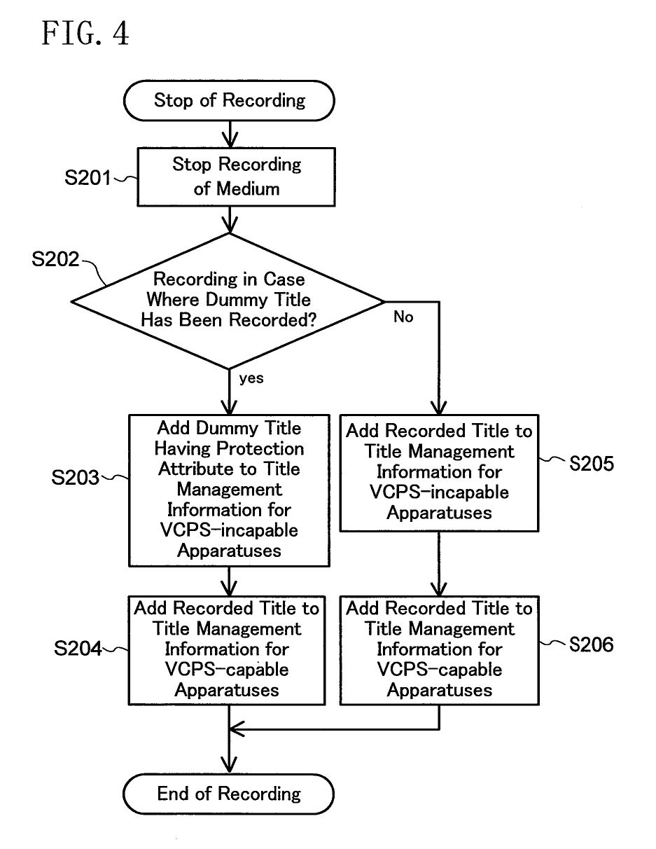

As shown in FIG. 4, the controller 105 stops recording of AV data onto the medium 109 in step S201, when detecting a user's recording stopping operation in the UI controller 102 or when detecting a state in which the medium 109 cannot be recorded, for example.

When it is detected in step S202 that a dummy title has been recorded, the dummy title is registered into a TT_SRPT (Title Search Pointer Table) 211 of the VMGI 208 in step S203. A dummy title attribute which has a protection attribute is recorded in the VRMI 207.

Next, in step S204, a VCPS title is registered only in a TT_SRPT_SA 213 for VCPS-capable apparatuses of a Reserved 212 of a VMGI_MAT (Video Manager Information Manager Table) 210 which is an extension in the VCPS recording method.

Also, when it is determined in step S202 that a dummy title has not been recorded, a conventional title is registered into both the TT_SRPT 211 and the TT_SRPT_SA 213 for VCPS-capable apparatuses of the “Reserved” 212 of the VMGI_MAT 210 (steps S205 and S206).

According to the VCPS title recording method of this embodiment, even when overwriting is performed from a deleted title immediately before a VCPS title in a VCPS-incapable apparatus, the recording is stopped as the dummy title has a protection attribute, whereby a user can be prevented from deleting the VCPS title.

### Embodiment 2

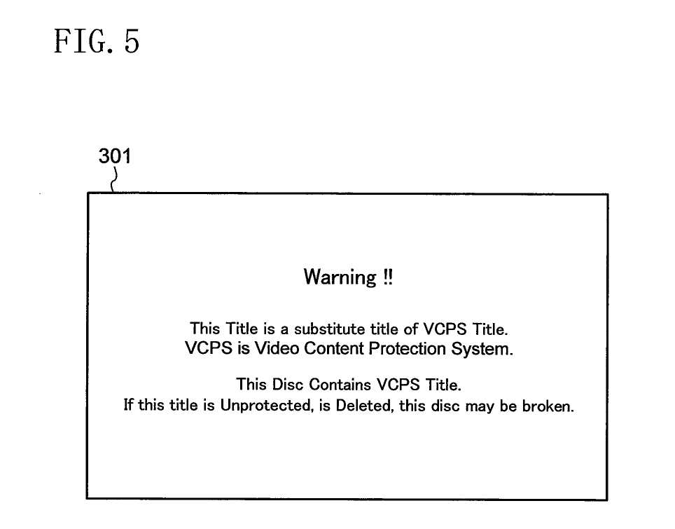

FIG. 5 shows AV data 301 indicating the contents of a dummy title in Embodiment 2 of the present invention.

The dummy title is a title which is played in a VCPS-incapable apparatus and is provided so as to protect a VCPS title. Therefore, the AV data of the dummy title indicates that a VCPS title, which can be played only by VCPS-capable apparatuses, is provided in an area adjacent to the dummy title, and the VCPS title is likely to be deleted by deleting the dummy title or overwriting the dummy title.

According to this embodiment, it is possible to notify that a dummy title is provided instead of a VCPS title, and a VCPS title is likely to be deleted by deleting the dummy title or canceling a protection attribute, whereby it is possible to warn a user about an operation or title editing in a VCPS-incapable apparatus.

### Embodiment 3

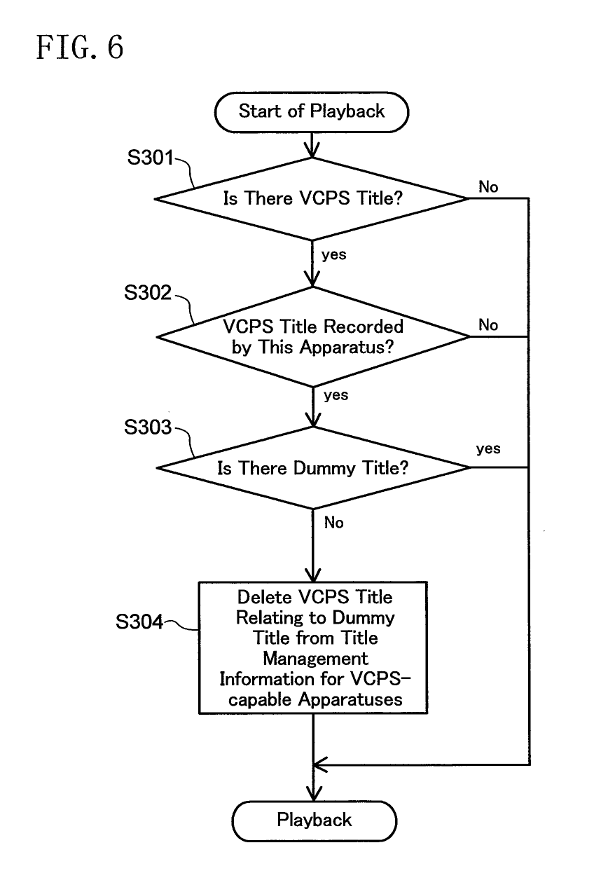

FIG. 6 is a flowchart for maintaining consistency so as to prevent only one of a dummy title and a VCPS title from being provided on a medium in Embodiment 3 of the present invention.

When it is detected in step S301 that a medium contains a VCPS title, and it is detected in step S302 that the medium contains a record indicating that the VCPS title was created in a recording and playback apparatus in which the medium is currently loaded, and it is detected in step S303 that there is no dummy title which was created during recording of the VCPS title, the VCPS title relating to a dummy title is deleted from title management information for VCPS-capable apparatuses in step S304.

Also, when the VCPS title is deleted, a pop-up message or the like may be used to ask a user to determine whether to permit deletion so as to maintain the consistency of title management information/medium.

According to this embodiment, it is possible to avoid a situation that only one of a dummy title and a VCPS title is provided in a medium, whereby consistency can be maintained between title management information for VCPS-incapable apparatuses and title management information for VCPS-capable apparatuses.

### Embodiment 4

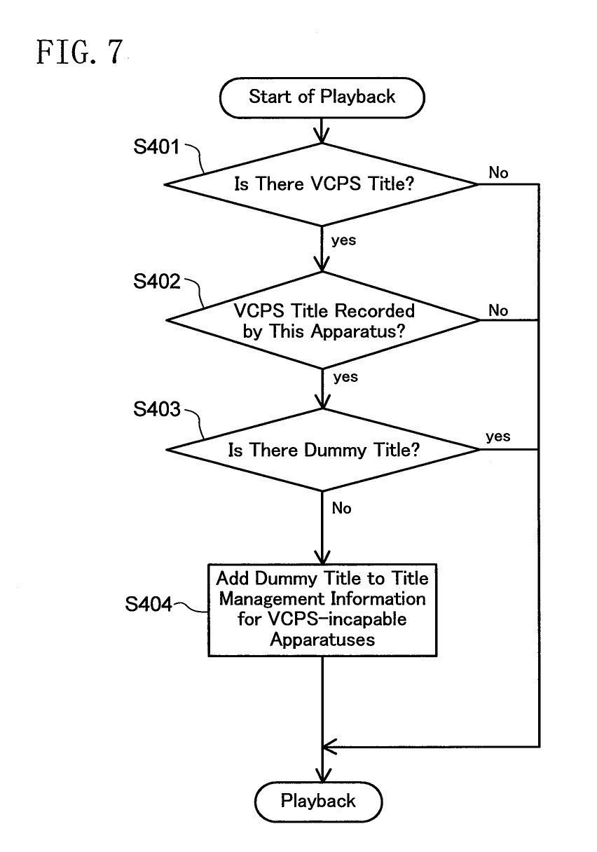

FIG. 7 is a flowchart for avoiding a situation that only one of a dummy title and a VCPS title is provided on a medium, so as to maintain consistency, in Embodiment 4 of the present invention.

When it is detected in step S401 that a medium contains a VCPS title, and it is detected in step S402 that the medium contains a record indicating that the VCPS title was created in a recording and playback apparatus in which the medium is currently loaded, and it is detected in step S403 that there is no dummy title which was created during recording of the VCPS title, a dummy title is added to title management information for VCPS-incapable apparatuses in step S404.

Also, when the dummy title is added, a pop-up message or the like may be used to ask a user to determine whether to permit addition of the dummy title so as to maintain the consistency of title management information/medium.

According to this embodiment, it is possible to avoid a situation that only one of a dummy title and a VCPS title is provided in a medium, whereby consistency can be maintained between title management information for VCPS-incapable apparatuses and title management information for VCPS-capable apparatuses.

### Embodiment 5

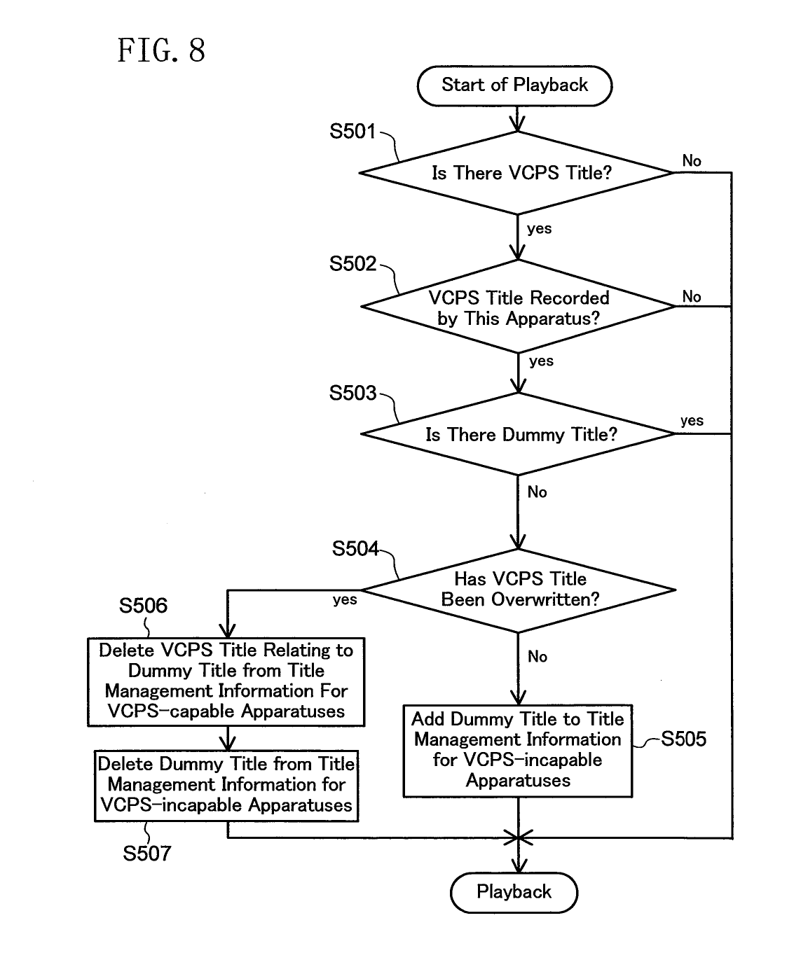

FIG. 8 is a flowchart for avoiding a situation that only one of a dummy title and a VCPS title from being provided in a medium, so as to maintain consistency, in Embodiment 5 of the present invention.

When it is detected in step S501 that a medium contains a VCPS title, and it is detected in step S502 that the medium contains a record indicating that the VCPS title was created in a recording and playback apparatus in which the medium is currently loaded, and it is detected in step S503 that there is no dummy title which was created during recording of the VCPS title, the VCPS title does not match a size, an update date and the like of title management information in step S504, and therefore, it is detected that overwriting has been performed by a VCPS-incapable apparatus or the like. As a result, if the VCPS title has been overwritten, the VCPS title relating to the dummy title is deleted from title management information for VCPS-capable apparatuses in step S506, and then the dummy title is deleted from title management information for VCPS-incapable apparatuses in step S507. If the VCPS title has not been overwritten, a dummy title is added to the title management information for VCPS-incapable apparatuses in step S505.

Also, a pop-up message or the like may be used to ask a user to determine whether to permit deletion of the VCPS title and addition of the dummy title so as to maintain the consistency of title management information/medium.

According to this embodiment, it is possible to avoid a situation that only one of a dummy title and a VCPS title is provided on a medium, whereby consistency can be maintained between title management information for VCPS-incapable apparatuses and title management information for VCPS-capable apparatuses.

### Embodiment 6

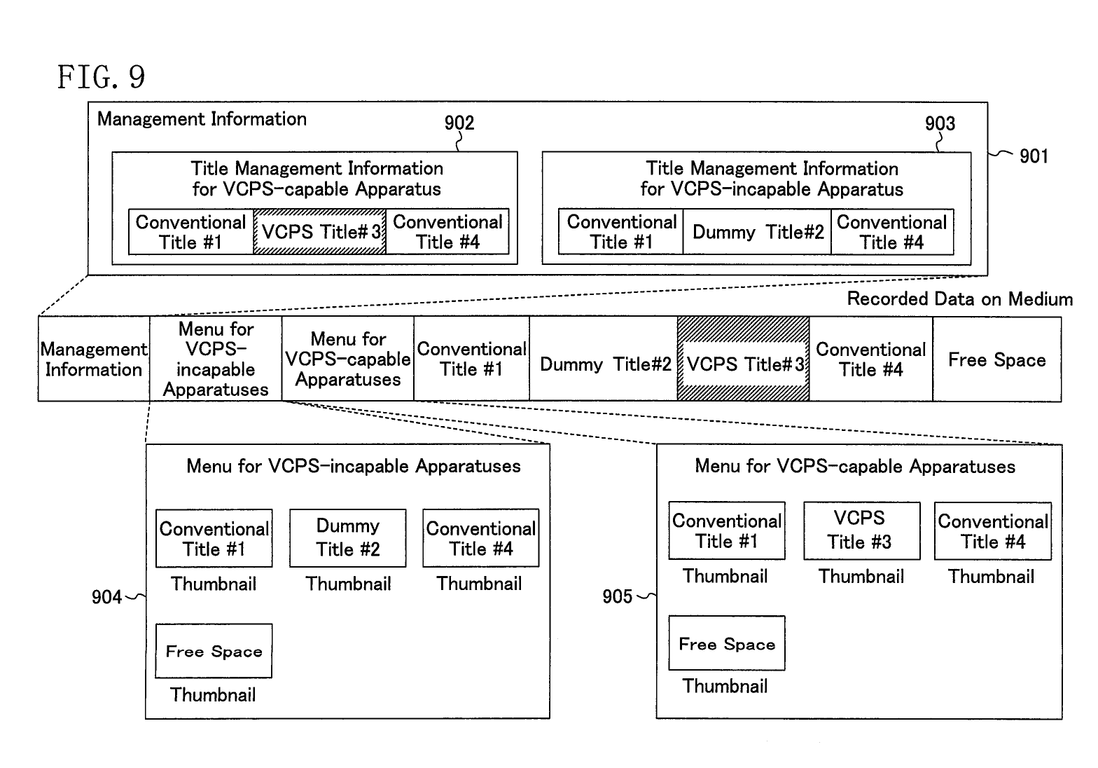

FIG. 9 is a diagram showing that a dummy title is used so as to create a menu for playback indicating a list of titles contained on a disk in Embodiment 6 of the present invention.

In the VCPS version 1.34 and thereafter of the DVD+VR recording method, a menu for VCPS-capable apparatuses and a menu for VCPS-incapable apparatuses are created as a VCPS-capable apparatus playback menu, thereby providing playback compatibility between VCPS-capable apparatuses and VCPS-incapable apparatuses.

Also, in the VCPS version 1.34, it is recommended that, in the menu for VCPS-incapable apparatuses, a thumbnail of a VCPS title is created at a portion where the VCPS title is provided, a link destination of the thumbnail is a new menu, and the new menu displays, for example, a message that a thumbnail which a user desires to play is a VCPS title, which cannot be played by a VCPS-incapable apparatus.

In contrast to this, according to this embodiment, a menu 905 for VCPS-capable apparatuses is created from a title registered in a VCPS-capable apparatus title management information 902 in a VCPS-capable apparatus, of management information 901 on a medium, and a menu 904 for VCPS-incapable apparatuses is created from a title registered in VCPS-incapable apparatus title management information 903. Also, in a VCPS-incapable apparatus, the menu 904 for VCPS-incapable apparatuses is created from the title registered in the VCPS-incapable apparatus title management information 903.

As a result, when the menu 904 for VCPS-incapable apparatuses is created, a thumbnail is created for a dummy title as with a conventional title. As a result, a menu having an effect similar to that of a recommendation operation (indicating that a VCPS title cannot be played in a VCPS-incapable apparatus) can be created without creating a new menu recommended in the VCPS version 1.34, and a free space of a medium can be ensured. Also, the menu 904 for VCPS-incapable apparatuses can be created only from the VCPS-incapable apparatus title management information 903. As a menu is created only from title management information, a procedure of creating the menu is simple.

### INDUSTRIAL APPLICABILITY

The recording and playback apparatus of the present invention, when a copyright content is recorded by the VCPS-capable DVD+VR recording method, can prevent overwriting which is not intended by a user in a VCPS-incapable apparatus, and therefore, is applicable as a DVD recording and playback apparatus or the like. The recording and playback apparatus of the present invention is also applicable to recording methods relating to Blu-ray disc or HD-DVD (containing a plurality of pieces of title management information).

### DESCRIPTION OF REFERENCE CHARACTERS

101 Recording and Playback Apparatus
102 UI Controller
103 CPU
104 Memory
105 Controller
106 Audio/Video Signal Source
107 Input Unit
108 Encoder
109 Medium
110 Drive Controller
111 Stream Controller
112 Decoder
113 Output Unit
114 Loudspeaker
115 Display
116 System LSI

1. A recording and playback apparatus for recording AV data and management information data of a program, as a title, into an information recording medium in accordance with an information recording format, the apparatus comprising:
an AV data recording unit configured to record AV data into successive recording areas with progression of time; and
a dummy title recording unit configured to record a dummy title into an area immediately before an area where AV data is recorded.

2. The recording and playback apparatus of claim 1, further comprising:
a dummy title protect setting unit configured to set a protection attribute for the dummy title.

3. The recording and playback apparatus of claim 2, further comprising:
a unit configured to record the dummy title as AV data indicating that the AV data is recorded as a copyright-protected title, but cannot be played.

4. The recording and playback apparatus of claim 2, further comprising:
a unit configured to record the dummy title as AV data indicating that a copyright-protected title is likely to be overwritten if the dummy title is deleted or overwritten.

5. The recording and playback apparatus of claim 1, wherein
when a copyright content is recorded by the AV data recording unit, information about a copyright-protected title and the dummy title is reflected on first title management information which is management information for copyright-protected title playback-capable apparatuses, and only information about the dummy title is reflected on second title management information which is management information for copyright-protected title playback-incapable apparatuses.

6. The recording and playback apparatus of claim 1, wherein
when AV data which is a copyright content is recorded as a copyright-protected title by the AV data recording unit, only information about the copyright-protected title is reflected on first title management information, and only information about the dummy title is reflected on second title management information.

7. The recording and playback apparatus of claim 1, further comprising:
a menu screen creating unit configured to create a playback menu screen which is a link destination of a copyright-protected title on a playback menu screen, using the dummy title rather than newly prepared AV data.

8. The recording and playback apparatus of claim 1, further comprising:
a title deleting unit configured to delete a copyright-protected title recorded along with the dummy title when the dummy title is deleted in another apparatus.

9. The recording and playback apparatus of claim 1, further comprising:
a title recovering unit configured to recover the dummy title when the dummy title is deleted in another apparatus.

10. The recording and playback apparatus of claim 8, wherein
the title deleting unit deletes a copyright-protected title only when the copyright-protected title is likely to have been overwritten.

11. The recording and playback apparatus of claim 1, wherein
the information recording format is the DVD+VR format.

12. An integrated circuit comprising:
an AV data recording unit configured to record AV data into successive recording areas with progression of time; and
a dummy title recording unit configured to record a dummy title into an area immediately before an area where AV data is recorded.
